(19) United States
(12) Patent Application Publication
(10) Pub. No.: US 2002/0194427 A1
(43) Pub. Date: Dec. 19, 2002

(54) System and method for storing data and redundancy information in independent slices of a storage device

(76) Inventor: Ebrahim Hashemi, Los Gatos, CA (US)

Correspondence Address: ROBERT C. KOWERT, CONLEY, ROSE & TAYON, P.C., P.O. BOX 398, AUSTIN, TX, 78767-0398, US

(21) Appl. No.: 09/883,616

(22) Filed: Jun. 18, 2001

(51) Int. Cl. G06F 13/00

(52) U.S. Cl. 711/114

(57) ABSTRACT

A storage system may include an array of storage devices and a storage controller. The storage controller may store data in stripes across the storage devices. Each stripe includes a plurality of stripe units that may be data stripe units and/or one or more redundancy stripe units. For each stripe, the stripe units are stored on different ones of the storage devices so that the stripe units are recoverable if one of the storage devices fails. Each of the storage devices is partitioned into a data slice and a redundancy slice. A data slice includes a plurality of contiguous segments of a storage device on which all data stripe units for that storage device are stored. The redundancy slice includes a plurality of contiguous segments independent from the data slice and on which all redundancy stripe units for that storage device are stored.

### BACKGROUND OF THE INVENTION

1. Field of the Invention

This invention relates to the arrangement of data and redundancy information in storage systems.

2. Description of the Related Art

A continuing desire exists in the computer industry to consistently improve the performance and reliability of computing systems over time. Impressive performance improvements have been achieved for the processing or microprocessor components of computing systems. Microprocessor performance has steadily improved over the years. However, the performance of the microprocessor or processors in a computing system is only one component of the overall performance of the system. For example, a computer's memory system must be able to keep up with the demands of the processor or the processor will become stalled waiting for data from the memory system. Generally, computer memory systems have been able to keep up with processor performance through increased capacities, lower access times, new memory architectures, caching, interleaving and other techniques.

Another critical component to the overall performance of a computer system is the I/O system performance. For many applications, the performance of the mass storage system or disk storage system is a critical performance component of a computer's I/O system. For example, when an application requires access to more data or information than it has room in allocated system memory, the data may be paged in/out of disk storage to/from the system memory. Typically the computer system's operating system copies a certain number of pages from the disk storage system to main memory. When a program needs a page that is not in main memory, the operating system copies the required page into main memory and copies another page back to the disk system. Processing may be stalled while the program is waiting for the page to be copied. If storage system performance does not keep pace with performance gains in other components of a computer system, then delays in storage system accesses may overshadow performance gains elsewhere.

Similarly, in network or fabric storage systems, the ability of a storage system on the network or fabric to promptly respond to storage requests is an important performance component. Multiple different requesters (e.g. computers) on the network or fabric may make storage requests to a storage system on the network or fabric. Servicing multiple different requestors further heightens the need for high performance from the storage system.

One method that has been employed to increase the capacity and performance of disk storage systems is to employ an array of storage devices. An example of such an array of storage devices is a Redundant Array of Independent (or Inexpensive) Disks (RAID). A RAID system may improve storage performance by providing parallel data paths to read and write information over an array of disks. By reading and writing multiple disks simultaneously, the storage system performance may be improved. For example, an array of four disks that can be read and written simultaneously may provide a data rate almost four times that of a single disk. However, using arrays of multiple disks comes with the disadvantage of increasing failure rates. In the example of a four disk array above, the mean time between failure (MTBF) for the array will be one-fourth that of a single disk. It is not uncommon for storage device arrays to include many more than four disks, shortening the mean time between failure from years to months or even weeks. RAID systems address this reliability issue by employing parity or redundancy so that data lost from a device failure may be recovered.

One common RAID technique or algorithm is referred to as RAID 0 and is illustrated in FIG. 1. RAID 0 is an example of a RAID algorithm used to improve performance by attempting to balance the storage system load over a number of disks. RAID 0 implements a striped disk array in which data is broken down into stripe units and each stripe unit is consecutively mapped to a separate disk drive. Thus, this technique may be referred to as striping. As an example, FIG. 1 illustrates four disk drives (devices 0-3). Data is stored in stripes across devices 0-3. For example, data stripe A is stored as stripe units A(0)-A(3) on devices 0-3 respectively. Thus, in this example, each stripe may have four stripe units with each strip unit stored on a separate device. A stripe unit may be a block of data, which is an amount of data manipulated by the system as a unit. Typically, I/O performance is improved by spreading the I/O load across multiple drives since blocks of data will not be concentrated on any one particular drive. However, a disadvantage of RAID 0 systems is that they do not provide for any data redundancy and are thus not fault tolerant.

RAID 5 is an example of a RAID algorithm that provides some fault tolerance and load balancing. FIG. 2 illustrates a RAID 5 system, in which both data and parity information are striped across the storage device array. In a RAID 5 system, the parity information is typically computed over fixed size and fixed location stripes of data that span a fixed number of the disks of the array. Together, each such stripe of data and its parity block form a fixed size, fixed location parity group. For example, data stripe units A(0)-A(2) and parity stripe unit A(P) form one parity group. As illustrated in FIG. 2, the parity stripe units are diagonally striped across the array to improve load balancing. This diagonal striping pattern is repeated over one set of disks for every n stripes where n is the number of stripe units (and disk drives) for each stripe.

When a subset of the data stripe units within a parity group is updated, the parity stripe unit is also updated. The parity may be updated in either of two ways. The parity may be updated by reading the remaining unchanged data blocks and computing a new parity in conjunction with the new blocks, or reading the old version of the changed data blocks, comparing them with the new data blocks, and applying the difference to the old parity. However, in either case, the additional read and write operations can limit performance. RAID 5 systems can withstand a single device failure by using the parity information to rebuild a failed disk. Since each stripe unit for a stripe is stored on a different disk, the stripe units on the failed disk can be reconstructed on a replacement or spare disk from the remaining stripe units.

However, in order to store the same amount of data blocks as a RAID 0 system, a RAID 5 system uses an additional storage device. Thus, a RAID 5 system trades off capacity for redundancy. Furthermore, if a second disk fails before or during reconstruction of a first failed disk, data will be lost. As the size of disk drives increases, so does the amount of time or number of operations required to reconstruct a failed disk. Thus, the chance of a second disk failure during reconstruction of a disk may not be insignificant.

If further reliability is desired, additional levels of redundancy may be added. For example, a system may employ two levels of redundancy, sometimes referred to as P and Q parities or two-dimensional parity. Such systems are sometimes referred to as RAID 6 systems. Each stripe (parity group) may include two redundancy stripe units, each calculated according to a different function, such as a Reed-Solomon function. The two functions applied to the data stripe units of a stripe may be solved as a set of equations with a unique solution to calculate the two redundancy stripe units. A system with two redundancy levels may be able to recover from two overlapping (in time) device failures within a redundancy group (e.g. stripe). However, the write performance typically suffers for each level of redundancy added, since the additional redundancy blocks have to be calculated and stored. Note that in both RAID 5 and RAID 6 systems, each stripe unit of a given stripe is stored on a different storage device than any of the other stripe units of that stripe to allow reconstruction in case of a disk failure.

### SUMMARY OF THE INVENTION

A storage system may include a storage array having a plurality of storage devices. A storage controller may be coupled to the storage devices. The storage controller may be configured to store data in stripes across the storage devices. Each stripe includes a plurality of stripe units. Stripe units may be data stripe units and/or one or more redundancy stripe units. For each stripe, the stripe units are stored on different ones of the storage devices so that one of the stripe units is recoverable if the storage device on which it is stored fails. The storage controller is configured to partition each of the storage devices into a data slice and a redundancy slice. On each storage device, the data slice includes a plurality of contiguous segments of the storage device and the storage controller is configured to store all data stripe units for that storage device in the data slice. The redundancy slice includes a plurality of contiguous segments of the storage device independent from the data slice and said storage controller is configured to store all redundancy stripe units for that storage device in said redundancy slice.

The storage controller may also be configured to add or delete levels of redundancy information. For example, second redundancy stripe units may be added to each stripe so that two of the stripe units are recoverable for each stripe in the case of two overlapping storage device failures. The storage controller may add the second redundancy stripe unit to each stripe by initially storing each second redundancy stripe unit in a redundancy slice of an additional storage device. In another embodiment, the storage controller may expand the data storage capacity of the storage system by expanding the size of said data slices and reducing or eliminating the size of said redundancy slices. Thus, storage capacity may be increased by removing a level of redundancy information. The data slice and redundancy slice partitions may also allow the storage controller to issue a read or write command to a storage device wherein the read or write command specifies a number of data stripe units to be accessed at consecutive locations on one of the storage devices. The number of consecutive locations may be greater than the number of stripe units in each stripe without running into a redundancy information boundary.

Other embodiments may include a data storage method in which data is stored as data stripe units within data slices on a plurality of storage devices and redundancy information for the data is stored as redundancy stripe units within redundancy slices on the plurality of storage devices. Each data slice comprises a plurality of contiguous segments of one of the storage devices and each redundancy slice comprises a plurality of contiguous segments of one of the storage devices independent from the data slice on that storage device.

### BRIEF DESCRIPTION OF THE DRAWINGS

FIG. 1 is a diagram of one embodiment of a conventional RAID 0 storage arrangement;

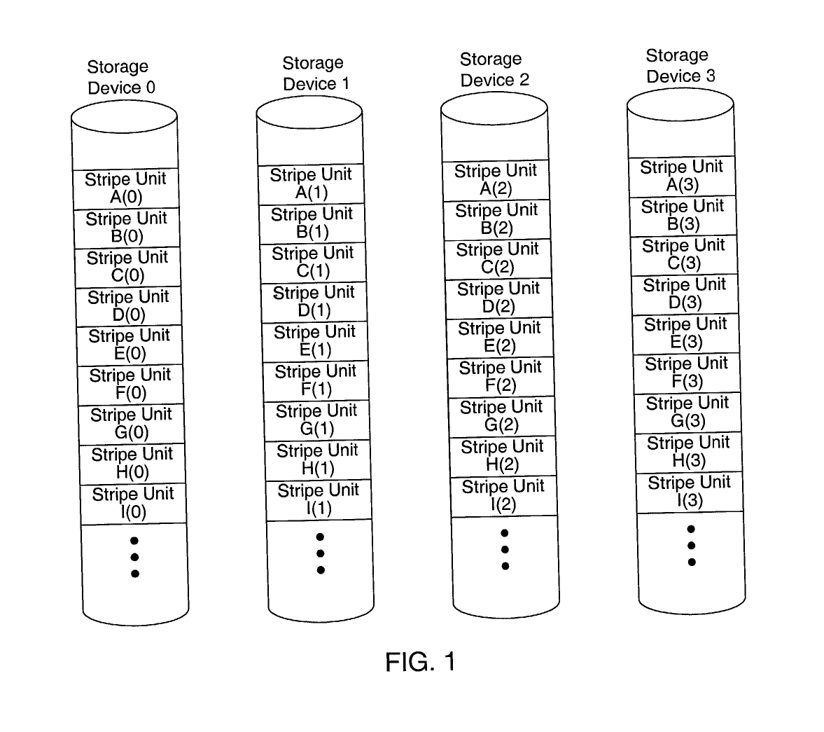

FIG. 2 is a diagram of one embodiment of a conventional RAID 5 storage arrangement;

FIG. 3 is a diagram of a data storage subsystem, according to one embodiment;

FIG. 4 illustrates a set of storage devices on which data and redundancy information are stored in accordance with an embodiment of the present invention;

FIG. 5 illustrates two sets of storage devices on which data and redundancy information are stored in accordance with an embodiment of the present invention; and

FIG. 6 illustrates a set of storage devices on which data and redundancy information are stored in accordance with an embodiment of the present invention in which the amount redundancy information has been changed.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

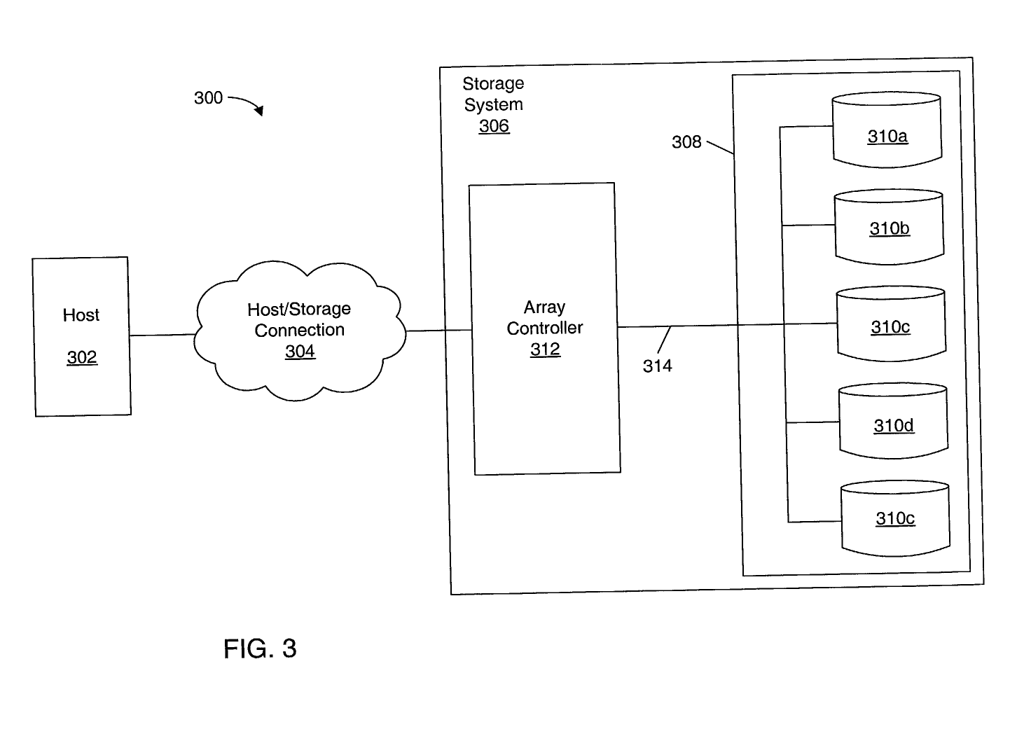

FIG. 3 shows a functional block diagram of a data processing system 300, which includes a host 302 connected to a storage system 306 via host/storage connection 304. Host/storage connection 304 may be, for example, a local bus, a network connection, an interconnect fabric, or a communication channel. Storage system 306 may be, a RAID storage subsystem or other type of storage array. In various embodiments, a plurality of hosts 302 may be in communication with storage system 306 via host/storage connection 304.

Contained within storage system 306 is a storage device array 308 which includes a plurality of storage devices 310a-310e. Storage devices 310a-310e may be, for example magnetic hard disk drives, optical drives, magneto-optical drives, tape drives, solid state storage, or other non-volatile memory. As shown in FIG. 3, storage devices 310 are disk drives and storage device array 308 is a disk drive array. Although FIG. 3 shows a storage device array 308 having five storage devices 310a-310e, it is understood that the number of storage devices 310 in storage device array 308 may vary and is not limiting.

Storage system 306 also includes an array controller 312 connected to each storage device 310 in storage array 308 via data path 314. Data path 314 may provide communication between array controller 312 and storage devices 310 using various communication protocols, such as, for example, SCSI (Small Computer System Interface), FC (Fibre Channel), FC-AL (Fibre Channel Arbitrated Loop), or IDE/ATA (Integrated Drive Electronics/Advanced Technology Attachment), etc.

Array controller 312 may take many forms, depending on the design for storage system 306. In a some systems, array controller 312 may only provide simple I/O connectivity between host 302 and storage devices 310 and the array management may be performed by host 302. In other storage systems 306, such as controller-based RAID systems, array controller 312 may also include a volume manger to provide volume management, data redundancy, and file management services. In other embodiments of the present invention, the volume manager may reside elsewhere in data processing system 300. For example, in software RAID systems, the volume manager may reside on host 302 and be implemented in software. In other embodiments, the volume manager may be implemented in firmware which resides in a dedicated controller card on host 302. In some embodiments, array controller being connected to one or more of the storage devices 310. In yet other embodiments, a plurality of array controllers 312 may be provided in storage system 306 to provide for redundancy and/or performance improvements.

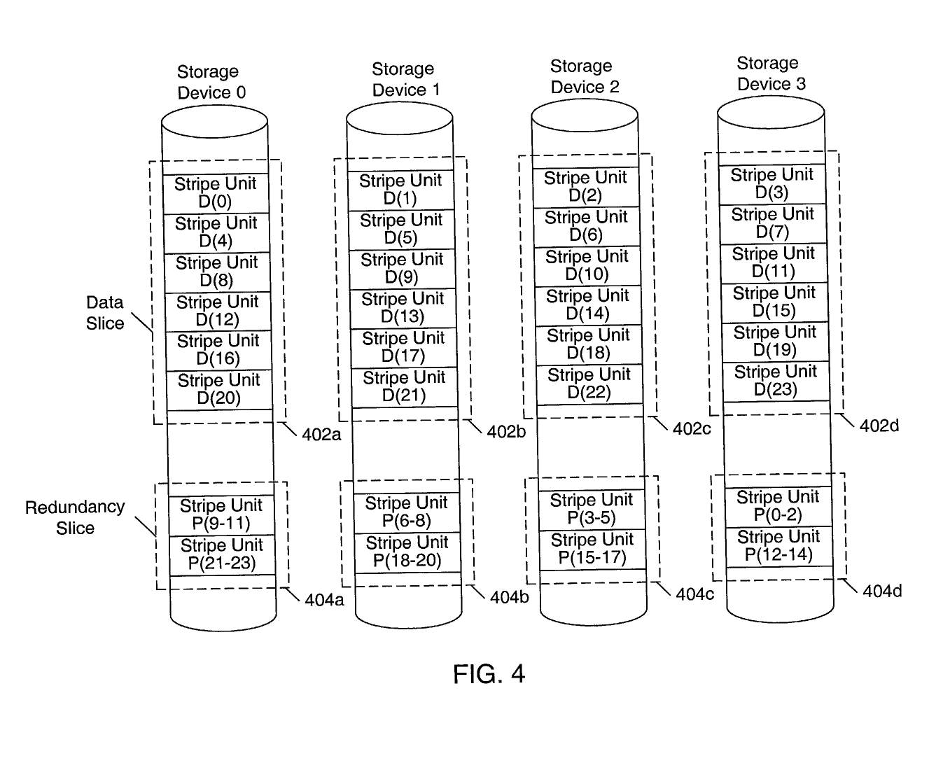

FIG. 4 illustrates a set of storage devices 0-3 on which data and redundancy information are stored in accordance with an embodiment of the present invention. The storage devices 0-3 may be part of a device array, such as storage device array 308 in FIG. 3. Storage devices 0-3 may be coupled to an array controller, such as an array controller 312 in FIG. 3. The array controller may be configured to partition each storage device into one or more data slices 402 and one or more redundancy slices 404. This partitioning may be a logical partitioning within the array controller governing how the array controller maps data and redundancy information to the storage devices. For each storage device, data is stored as data stripe units (e.g. stripe units D(0)-D(23)) and redundancy information is stored as redundancy stripe units (redundancy stripe units P(0-2)-P(21-23)). For each storage device, all data stripe units may be stored in the storage device's data slice and all redundancy stripe units may be stored in the device's redundancy slice. The data slice may be a group of contiguous segments of the storage device independent from the redundancy slice. Likewise, the redundancy slice may be a group of contiguous segments of the storage device independent from the data slice on that storage device. Thus, all data may be stored in one contiguous region of the storage device and all redundancy information stored in a separate independent contiguous region of the storage device.

Data and redundancy information may be stored as stripe units on each storage device. A stripe unit may be an amount of data or redundancy information manipulated by the array controller as a unit, (e.g. a data block). Data may be striped across the storage devices in data stripe units. For example, FIG. 4 illustrates data strip units D(0)-D(23) stored in the data slice 402 of each storage device. Thus, the data stripe units may be distributed across the storage devices to improve load balancing.

Redundancy information may also be distributed across the storage devices in the stripe units in the redundancy slice 404 of each storage device. FIG. 4 illustrates redundancy stripe units P(0-2)-P(21-23). FIG. 4 illustrates an embodiment in which one level of redundancy is provided for the data stored on storage devices 0-3. For example, redundancy strip unit P(0-2) provides redundancy information (e.g. parity) for data stripe units D(0)-D(2). Similarly redundancy P(3-5) provides redundancy information for data stripe units D(3)-D(5), and so on. A set of data stripe units and the redundancy stripe unit(s) for those data stripe units may be referred to as a stripe or redundancy group. Thus, data stripe units D(0)-D(2) and redundancy stripe unit P(0-2) comprise one stripe on storage devices 0-3. Likewise, data strip units D(3)-D(5) and redundancy strip unit P(3-5) comprise a second stripe on storage devices 0-3. In some embodiment, for each stripe, no two stripe units may be stored on the same storage device, in order for all the stripe units to be recoverable in case of a device failure.

The organization of data stripe units in data slices and redundancy stripe units in redundancy slices independent from the data slices may provide for efficient read and write operations. For example, data stripe units D(0)-D(3) may be mapped to consecutive logical block addresses. Thus, a read of data including data stripe units D(0)-D(3) may be distributed across storage devices D0 to D3. The storage controller may also attempt to arrange data stripe units within the data slice of each storage device at consecutive physical addresses on that storage device. For example, data stripe units D(0), D(4), D(8), D(12), D(16) and D(20) may be stored at consecutive physical addresses on storage device 0. This arrangement may allow a single read command to storage device 0 to stream a large amount of uninterrupted data from the storage device. For example, if a read of a large amount of data is desired, for example including data stripe units D(0)-D(23), a single read command may be issued to each storage device 0-3. For example, data stripe units D(0), D(4), D(8), D(12), D(16) and D(20) may be read from storage device 0 with a single read command while similar read commands are issued to storage devices 1-3.

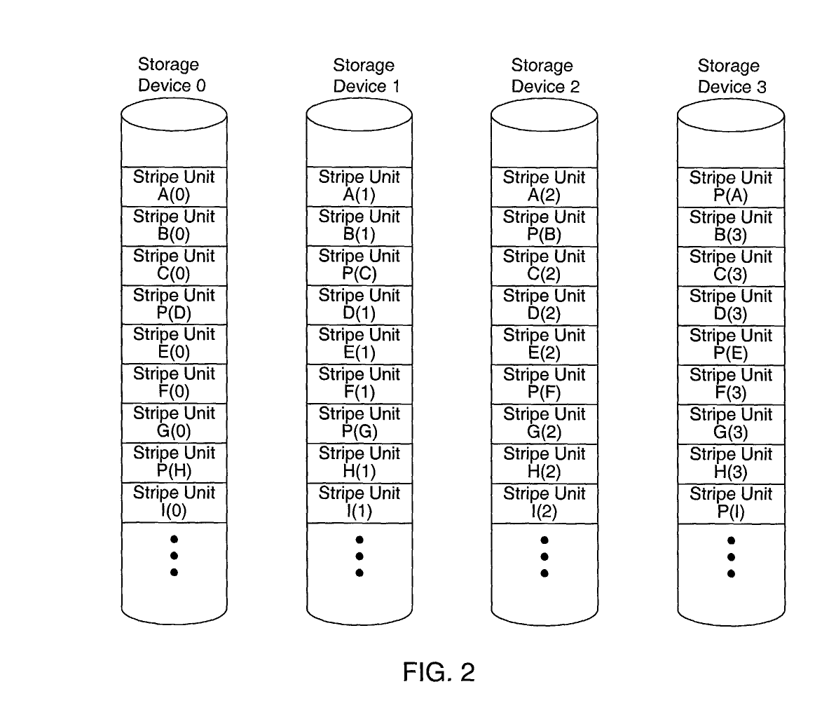

Compare to a conventional RAID 5 system such as illustrated in FIG. 2 where the data stripe units are interspersed with parity stripe units. Only a few data stripe units may be read from each storage device before encountering a parity stripe unit. Thus, for a large read operation, multiple read commands may have to be issued to each storage device to skip over the parity stripe unit locations. Alternatively, if a single read command is used, the array controller will have to remove the parity stripe units from the data read from each storage device. This complicates the read operation for the array controller. However, the data slice and redundancy slice organization, as illustrated in FIG. 4 for example, may provide for large data reads by a single command to each device without hitting a redundancy boundary.

The data slice and redundancy slice organization of the present invention may also allow for efficient write operations. For example, for large writes the data and redundancy stripe units may be streamed with separate commands. For example, if a data write is requested for data including data stripe units D(0)-D(23), a single write command may be issued to each storage device for the data to be written to each data slice. A separate write command may also be issued for the redundancy stripe units to be written in each redundancy slice. For a large number of writes, seek time on the storage devices may be improved via an elevator algorithm. With an elevator algorithm, commands may be sorted according to the direction of the disk actuator (seek direction). Commands addressing disk locations in the current see direction may be ordered ahead of commands for locations in the opposite direction. The amount of command reordering may be limited to prevent starvation for commands in the other direction. For example, 32 commands may be sorted in ascending order and the subsequent 32 commands sorted in descending order of block addresses.

Note that in conventional stripe unit algorithms, such as RAID 5, the data and parity stripe units are striped in a repeating pattern together across the storage devices. Typically the pattern repeats on each storage device after a number of stripe units equal to the width of each stripe. Thus, large reads or writes for each storage device in a conventional system will encounter boundaries between data and redundancy information on the storage device. These boundaries necessitate the use of multiple separate commands to the storage device to bypass the redundancy boundaries or require further complication in the read or write algorithms used by the array controller. The data slice and redundancy slice organization of the present invention may allow large reads or writes to be streamed from or to a storage device without encountering a boundary between the data and redundancy information.

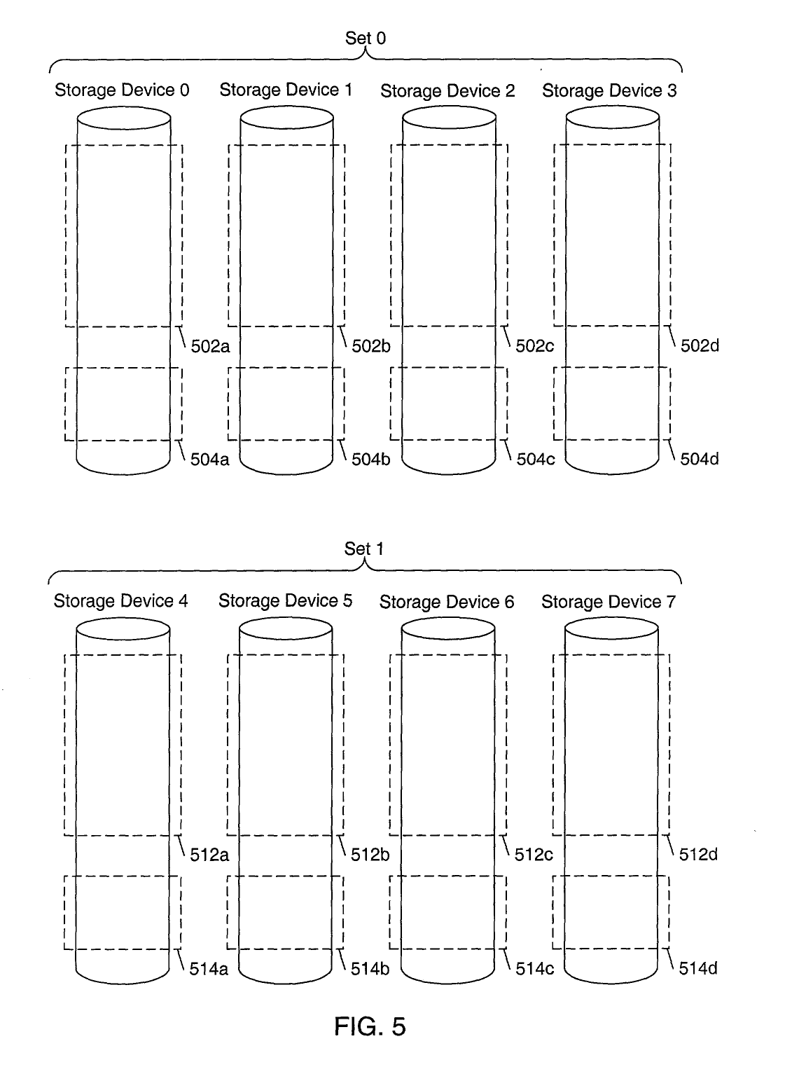

As discussed above, a stripe includes the data stripe units and corresponding redundancy stripe unit(s). For each stripe, each stripe unit is stored on a separate storage device to allow for recovery in case of a device failure. However, note that the redundancy stripe units stored in independent redundancy slices may be stored in the same set or a different set of storage devices as their corresponding data stripe units. For example, FIG. 5 illustrates two sets of storage devices, set 0 and set 1. Set 0 comprises data slices 502 and redundancy slices 504. Set one comprises data slices 512 and redundancy slices 514. The data stripe units stored in data slices 502 may have their corresponding redundancy stripes units stored in redundancy slices 504, such as shown in FIG. 4. However, in other embodiments, the redundancy stripe units corresponding to the data stripe units stored in data slices 502 may be stored in redundancy slices 514. Redundancy slices 504 may store redundancy stripe units corresponding to data stripe units stored in 512. In other embodiments, the redundancy stripe units corresponding to the data stripe units and data slices 502 may be distributed throughout both redundancy slices 504 and 514. The redundancy stripe units corresponding to data slice 512 may be similarly distributed. For each redundancy group (i.e. stripe), each stripe unit is stored on a different storage device. However, the data stripe units and redundancy stripe units for each stripe do not have to be stored on the same set of storage devices as in conventional RAID systems. In one embodiment, set 0 may be coupled to a first port of an array controller and set 1 may be coupled to a second port of an array controller.

Some embodiments of the present invention allow for increasing or reducing the number of levels of redundancy provided by the redundancy information stored in the redundancy slices. The increase or decrease may result in a change in the allocation of storage between data slices and redundancy slices. This expanding or contracting of levels of redundancy may be performed dynamically during system operation. The expanding or contracting of levels of redundancy may also be performed without disturbing the current organization of data and redundancy stripe units. For example, if storage devices 0-3 shown in FIG. 4 begin to run low on data storage capacity, the size of redundancy slices 404 may be contracted and the size of data slices 402 may be expanded in order to provide for more data storage capacity. The expansion of data slices 402 may come at a loss of redundancy information if the data slices expand into regions of the storage device previously occupied by redundancy 404. Thus, redundancy protection may be traded off for data storage capacity. This tradeoff may be performed dynamically during system operation in some embodiments. In some embodiments redundancy 404 may be shrunk gradually as more data storage capacity is desired. In other embodiments, an entire level of redundancy may be effectively deleted by shrinking or eliminating redundancy slice 404 by the amount of space occupied by a level of redundancy information.

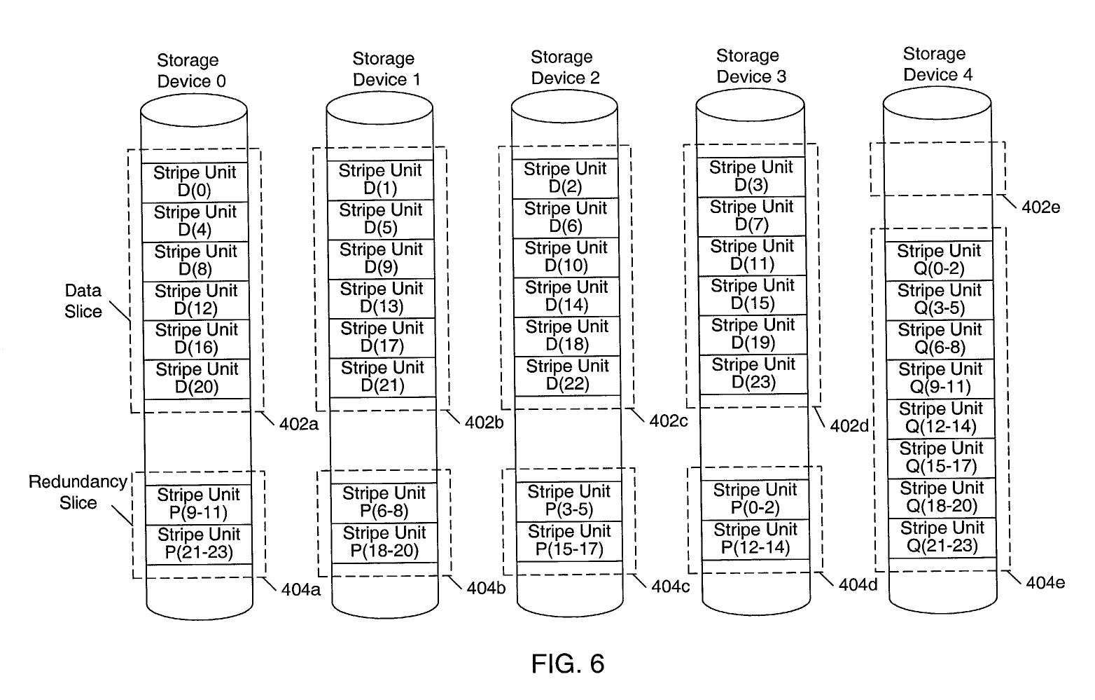

FIG. 6 illustrates an embodiment in which the redundancy information has been increased by one level. For example, one or more additional storage devices may be added and the new level of redundancy information may initially be stored on the one or more additional storage devices. Alternatively, one or more spares or other drive(s) with sufficient available space may be selected for storing the new level of redundancy information. FIG. 6 illustrates an example in which storage device 4 has been added and a second level of redundancy information for the data stored in storage devices 0-3 has been stored in redundancy slice 404e of storage device 4. The second level of redundancy information is illustrated as redundancy stripe units Q(0-2)-Q(21-23) in FIG. 6. The new level of redundancy information may initially be added to the additional storage device without disturbing the organization of the current data stripe units and redundancy stripe units. In some embodiment, the additional level of redundancy may be added dynamically during system operation.

Later the new redundancy stripe units and data may be gradually distributed across all the storage devices to improve load balancing. For example, data may be stored in data slice 402e of storage device 4 and some of the redundancy stripe units Q may be moved to redundancy slices 404a-d. However, for each stripe, no two stripe units are stored on the same storage device. For example, for the stripe including data stripe units D(0)-D(2) redundancy stripe unit P(0-2) and redundancy stripe unit Q(0-2), each stripe unit is stored on a separate storage device. Thus, the storage controller may be configured to add a second redundancy stripe unit to each stripe so that the stripe units stored on up to two storage devices may be recoverable in the case of two overlapping storage device failures. The second redundancy stripe unit may be added for each stripe without changing the storage location of the original data stripe units and redundancy stripe units for each stripe. The amount of redundancy protection may be extended in a similar manner for additional levels of redundancy. For example, a third level of redundancy information may be added in a redundancy stripe on an additional storage device.

Each level of redundancy information may be calculated according to a different function. For example, in the case of two levels of redundancy, a first redundancy stripe unit for each stripe may be calculated according to a function P and a second redundancy stripe unit for each stripe may be calculated according to a function Q. The P function and Q function may each be applied to the data stripe units of a stripe to form a set of linear equations with a unique solution for each of the redundancy stripe units. Thus, if the system experiences two overlapping storage device failures, the P and Q functions may be solved together for the remaining stripe units of each stripe to reconstruct the stripe units of the failed devices onto replacement or spare storage devices. The P and Q functions may be different type of parity or different Reed-Solomon encodings, for example.

Various embodiments may further include receiving, sending or storing instructions and/or data implemented in accordance with the foregoing description upon a computer readable medium. Generally speaking, a computer readable medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link. Such a medium may, for example, be included in the system of FIG. 3 as part of host 302, connection 304, array controller 312, and/or elsewhere.

Numerous variations and modifications will become apparent to those skilled in the art once the above disclosure is fully appreciated. For example, each storage device may have more than one data slice and more than one redundancy slice, wherein each slice is a contiguous section configured to store a plurality of stripe units. It is intended that the following claims be interpreted to embrace all such variations and modifications.

What is claimed is:

1. A storage system, comprising:
a storage array comprising a plurality of storage devices;
a storage controller coupled to said plurality of storage devices, wherein said storage controller is configured to store data in stripes across said storage devices, wherein each stripe comprises a plurality of stripe units comprising data stripe units and a first redundancy stripe unit;
wherein said storage controller is further configured to partition each said storage device into a data slice and a redundancy slice; wherein for each storage device, said data slice comprises a plurality of contiguous segments of the storage device and said storage controller is configured to store all data stripe units for that storage device in said data slice, and said redundancy slice comprises a plurality of contiguous segments of the storage device independent from the data slice and said storage controller is configured to store all redundancy stripe units for that storage device in said redundancy slice.

2. The storage system as recited in claim 1, wherein said storage controller is further configured to add a second redundancy stripe unit to each stripe so that two of said stripe units are recoverable for each stripe in the case of two overlapping storage device failures.

3. The storage system as recited in claim 2, wherein said storage controller is further configured to add said second redundancy stripe unit to each stripe without changing the storage location of the data stripe units and first redundancy stripe unit for each stripe.

4. The storage system as recited in claim 2, wherein before said second redundancy stripe units are added, said storage controller is configured to store each stripe across a first number of said storage devices, wherein said storage controller is configured to add said second redundancy stripe unit to each stripe by initially storing each second redundancy stripe unit in a redundancy slice of an additional storage device so that after said second redundancy stripe units are added, said storage controller is configured to store each stripe across said first number of said storage devices plus said additional storage device, wherein said redundancy slice of said additional storage device comprises a plurality of contiguous segments of the additional storage device and said storage controller is configured to not store data stripe units in said redundancy slice of said additional storage device.

5. The storage system as recited in claim 1, wherein said storage controller is configured to expand the size of said data slices and reduce or eliminate the size of said redundancy slices.

6. The storage system as recited in claim 1, wherein said storage controller is configured issue a first read command to one of said storage devices, wherein said first read command requests a first number of data stripe units stored at consecutive locations on said one of said storage devices.

7. The storage system as recited in claim 6, wherein said first number is greater than the number of stripe units in each stripe.

8. The storage system as recited in claim 7, wherein said storage controller is configured to issue a second read command to another one of said storage devices concurrently with said first read command, wherein said second read command requests a plurality of data stripe units stored at consecutive locations on said another one of said storage devices.

9. The storage system as recited in claim 1, wherein said storage controller is configured issue a first write command to one of said storage devices, wherein said first write command specifies a write of a first number of data stripe units to consecutive locations on said one of said storage devices.

10. The storage system as recited in claim 9, wherein said first number is greater than the number of stripe units in each stripe.

11. The storage system as recited in claim 10, wherein said storage controller is configured to issue a second write command to another one of said storage devices concurrently with said first write command, wherein said second write command specifies a write of a plurality of data stripe units to consecutive locations on said another one of said storage devices.

12. A data storage method, comprising:
storing data as data stripe units within data slices on a plurality of storage devices; and
storing redundancy information for said data as redundancy stripe units within redundancy slices on the plurality of storage devices;
wherein each data slice comprises a plurality of contiguous segments of one of the storage devices and each redundancy slice comprises a plurality of contiguous segments of one of the storage devices independent from the data slice on that storage device.

13. The method as recited in claim 12, wherein said data stripe units and redundancy stripe units are related by stripes, wherein each stripe comprises a plurality of the data stripe units and at least one redundancy stripe unit for the data stripe units of the stripe; wherein, for each stripe, each data stripe unit and redundancy stripe unit is stored on a separate one of the storage devices.

14. The method as recited in claim 13, wherein said storing data stripe units comprises issuing a single write command to one of the storage devices, wherein the single write command specifies a plurality of the data stripe units to be written to consecutive physical addresses in the data slice of the storage device receiving the single write command, wherein each of the data stripe units specified by the single write command is associated with a different one of said stripes.

15. The method as recited in claim 14, wherein each stripe comprises a first number of data and redundancy stripe units, and wherein a number of the data stripe units specified by the single write command to be consecutively written is greater than said first number.

16. The method as recited in claim 14, further comprising, concurrent with said issuing a single write command, issuing a second single write command to another one of the storage devices, wherein the second single write command specifies a second plurality of the data stripe units to be written to consecutive physical addresses in the data slice of the storage device receiving the second single write command, wherein each of the data stripe units specified by the second single write command is associated with a different one of said stripes.

17. The method as recited in claim 14, further comprising issuing a second single write command to another one of the storage devices, wherein the second single write command specifies a plurality of the redundancy stripe units to be written to consecutive physical addresses in the redundancy slice of the storage device receiving the second single write command, wherein each of the redundancy stripe units specified by the second single write command is associated with a different one of said stripes.

18. The method as recited in claim 13, further comprising issuing a single read command to one of the storage devices, wherein the single read command specifies a plurality of the data stripe units to be read from consecutive physical addresses in the data slice of the storage device receiving the single read command, wherein each of the data stripe units specified by the single read command is associated with a different one of said stripes.

19. The method as recited in claim 18, wherein each stripe comprises a first number of data and redundancy stripe units, and wherein a number of the data stripe units specified by the single read command to be consecutively read is greater than said first number.

20. The method as recited in claim 13, further comprising adding an additional redundancy stripe unit to each stripe so that each stripe may be recovered in case of one more overlapping storage device failure than before said adding an additional redundancy stripe unit.

21. The method as recited in claims 20, wherein said adding an additional redundancy stripe unit comprises storing the additional stripe unit for each stripe within a redundancy slice of a storage device added to the plurality of storage devices.

22. The method as recited in claim 12, further comprising expanding the size of each data slice by extending the data slice over at least a portion of the redundancy slice for each storage device.

23. The method as recited in claim 22, wherein said expanding the size of each data slice comprises removing a level of redundancy protection provided by said redundancy information.

24. The method as recited in claim 12, further comprising expanding the size of each redundancy slice by extending the redundancy slice over at least a portion of the data slice for each storage device.

25. The method as recited in claim 24, wherein said expanding the size of each redundancy slice comprises adding a level of redundancy protection provided by said redundancy information.

26. A storage system, comprising:
a storage array comprising a plurality of storage devices, each of said storage devices including a contiguous data slice and a contiguous redundancy slice; and
a controller coupled to said plurality of storage devices, wherein said controller is configured to store data in stripes across said storage devices, wherein each stripe comprises a plurality of stripe units comprising data stripe units and a redundancy stripe unit;
wherein for each storage device, said controller is configured to store each data stripe unit in the contiguous data slice and each redundancy stripe unit in the contiguous redundancy slice.
